(19) United States
(12) Patent Application Publication
(10) Pub. No.: US 2016/0350623 A1
(43) Pub. Date: Dec. 1, 2016

(54) HAND-HELD QR CODE LABEL PRINTER USING INKJET PRINTING

(71) Applicants: Daniel T. Liguori, San Diego, CA (US); Thomas A. Ligouri, San Diego, CA (US)

(72) Inventors: Daniel T. Liguori, San Diego, CA (US); Thomas A. Ligouri, San Diego, CA (US)

(21) Appl. No.: 14/720,910

(22) Filed: May 25, 2015

(51) Int. Cl. G06K 15/02; G06K 15/10; G06K 1/12; B41J 3/01; B41J 3/407

(52) U.S. Cl. CPC G06K 15/024; B41J 3/01; B41J 3/4075; G06K 1/121; G06K 15/102; G06K 15/022

(57) ABSTRACT

A hand-held portable QR Code label printer has a keypad and display screen for inputting data; a QR Code generator for converting the data into a QR Code; an inkjet printing system for printing the QR code from the QR Code generator on a label; a delivery system for moving the labels on a roll to the inkjet printing system and then moving the QR Code printed label through an exit port. A controller controls the components of the QR Code label printer. A battery power source supplies the power for the components of the QR Code label printer. A housing will support the keypad and display screen externally and support the QR Code generator, the inkjet printing system, the delivery system, the battery power source and the controller internally. The QR Code printed label can be attached to an item to be scanned and the inputted data displayed.

### CROSS-REFERENCE TO RELATED APPLICATIONS

This application is related to U.S. patent application Ser. No. ______ entitled “HAND-HELD QR CODE LABEL PRINTER USING A SMARTPHONE”, U.S. patent application Ser. No. ______ entitled “HAND-HELD QR CODE LABEL PRINTER USING THERMAL TRANSFER PRINTING”, and to U.S. patent application Ser. No. ______ entitled “HAND-HELD QR CODE LABEL PRINTER USING LASER PRINTING,” all three related patent applications which are filed concurrently with this patent application and which are herein incorporated by reference.

### BACKGROUND OF THE INVENTION

This invention relates generally to a label printer and, more particularly, this invention is directed to a hand-held, portable QR Code label printer using an inkjet printing system.

A QR (Quick Response) Code is a two-dimensional (2-D) matrix code which is machine readable. A matrix code is composed of small, symmetrical elements arranged in a square or rectangle.

A barcode is a one-dimensional (1-D) code which conveys information by the size and position of bars and spaces in a single (horizontal) dimension.

A QR Code conveys information by the arrangement of its dark and light elements, called “modules,” in columns and rows, i.e. in two dimensions, both the horizontal and vertical directions.

Each dark or light module of a QR Code symbol represents a 0 or 1, thus making it machine intelligible. The required data can then extracted from patterns present in both horizontal and vertical components of the QR Code symbol.

QR codes are designed to be read and the converted data displayed (1) by computers using machine-vision systems consisting of optical laser scanners or (2) by smartphones or cameras with QR Code barcode-interpreting software.

The QR Code is designed with special position-detection patterns located in three of the four corners of each square symbol. The patterns have a symmetrical scan-line ratio of 1:1:3:1:1, which allows them to be scanned from any direction within a full 360 degrees.

As a result, the QR Code does not require lengthy code searching. A QR Code has reading speeds 20 times faster than those of conventional one dimensional barcodes and other two dimensional codes.

QR Codes can be generated in 40 different symbol versions, from 21×21 modules (version 1) to 177×177 modules (version 40). A single QR Code symbol can contain up to 7,089 numerals—over 200 times the amount of data as a traditional 1-D barcode.

A QR Code can hold a larger amount of data in a smaller space than a bar code because a QR Code contains information in both the horizontal and vertical direction. A QR Code can hold the same amount of data contained in a 1-D barcode in only one-tenth the space.

The QR Code can convert and then reconvert and display numerals, alphabetic characters, symbols, Japanese, Chinese or Korean characters and binary data.

QR Codes are used in a wide range of applications. A QR Code label can track and identify products and orders, provide point-of-purchase product identification, provide inventory control, maintain records and manage documents, create tickets and boarding passes, and create customer coupons.

QR code labels for displaying text or Uniform Resource Locators (URLs) may appear on signs, on buses, on business cards, or on almost any object about which users might want information.

Typically, a smartphone with the correct reader application can scan the image of the QR code to display text, contact information, connect to a wireless network, or open a web page in the telephone's browser.

A typical label maker consists of a desktop computer connected to a desktop printer. Data for the label is entered into the computer and a label is designed by the user utilizing programs running on the computer. The designed label image, picture or file is transmitted to the printer via a cable or via a wireless connection. The printer prints the label upon command by the computer or upon command by a print button on the printer.

Most printers operate in one of three fashions. Paper is moved mechanically under a stationary printing element. A printing element is moved mechanically across stationary paper. Or a printing element is moved across moving paper, both printing element and paper moving by mechanical means, usually in opposite directions to each other.

Conventional line printers do not combine the functions of data input, QR Code generation and a printer in one device. Typically a computer is used for data input and QR Code generation and then a separate printer.

The conventional desktop label printer is not portable. The data must be input, the QR Code generated, the label printed elsewhere, and then the label is transported to the location of use. The conventional desktop label printer cannot generate a QR Code from data and print a QR Code label at the object location where the label is to be attached to an object.

Conventional label printers are too large and too awkwardly shaped to be hand-held.

Conventional label printers are not rugged enough to be mobile or used at an indoor label location or and outside label location, where the label is generated and printed and then attached to an object

Therefore, a hand-held, portable QR Code label printer is desired.

It is, therefore, an object of the present invention to provide a single device which inputs data, generates a QR Code and prints a QR Code label.

It is another object of this invention to provide a small, rugged, hand-held portable label printer.

### SUMMARY OF THE INVENTION

According to the present invention, a hand-held portable QR Code label printer has a keypad and display screen for inputting data to a controller. The inputted data from the controller will be converted by a QR Code generator into a QR Code. One or more labels are positioned on a label roll. A delivery system moves the labels on the roll to an inkjet printing system. An inkjet printing system prints the QR code from the QR Code generator on a label. After the inkjet printing system has printed the QR code on the label, the delivery system moves the QR Code printed label through an output aperture.

A controller controls the keypad and display screen, the QR Code generator, the inkjet printing system, and the delivery system. A battery power source supplies power to the keypad and display screen, the QR Code generator, the inkjet printing system, the delivery system and the controller.

A housing externally supports the keypad and display screen. The housing internally contains and supports the QR Code generator, the inkjet printing system, the delivery system, the battery power source and the controller. The housing is hand held and portable by the user.

The QR Code printed label can be attached to an object. The QR Code will be scanned and converted back to the data by a smartphone and the inputted data displayed.

The keypad (or a keyboard) is used to enter the alphanumeric and symbol data for the QR Code and to control the label printer. Function keys on the keypad can control the label printer. The display is used to show the inputted data and the status of the label printing system.

The controller receives operational commands from the function keys of the keypad. The controller controls the delivery system, the inkjet printing system and the QR Code generator. The controller is one or more application-specific integrated circuits (ASICs).

The QR Code generator is an application-specific integrated circuit (ASIC). The ASIC is an integrated circuit with a memory and a microprocessor customized to generate a QR Code.

The data is entered into the keypad, shown on the display, and transmitted to the controller. The controller will input the data to the QR Code generator which will convert the inputted data into a QR Code. The QR Code generator, under the direction of the controller, will transmit the QR Code to the inkjet print head of the printing system to be printed on the label.

The label has a top surface with a printable surface for the QR Code to be printed on and a bottom surface with an adhesive layer. The adhesive layer on the bottom surface of the label releasably secures the label to the top surface of a liner. The user can remove the label from the liner with the adhesive layer intact on the label to secure the label to an object. The liner can have a perforation line between adjacent labels to separate labels.

The housing for the label printer has an internal compartment for mounting a label roll on a spindle. The label roll is guided along a delivery path through the interior of the label printer. The labels will be feed out of the spindle, a QR Code will be printed on the label at the inkjet print head, and then the labels will exit the label printer through an output aperture for use.

An electric motor, a drive roller and opposing pairs of passive rollers will advance the label along the delivery path and position the label under the inkjet print head for printing the QR Code on the label.

The power source in the QR Code label printer is one or multiple batteries. The batteries can be removed and replaced from the battery compartment inside the housing. The batteries are disposable or rechargeable.

The bottom surface of the housing can be convex curved or ergonomically shaped for being held by either the right or left hand of the user.

Openings in the housing allow for removal and replacement of components inside the housing for the label roll, the battery power source and the inkjet print cartridge. Openings in the housing allow for the realignment and repositioning of the label along the delivery system path inside the housing. The openings will have a hinged cover with a latch to close the opening.

Alternatively, a position sensor above the delivery path and a reference mark on the liner of the label can determine and correct the position of the label with respect to the inkjet print head.

Alternately, a hand grip handle can extend generally perpendicular to the flat bottom surface of the label printer. The user will grip the handle in the user's hand rather than hold the label printer in the palm of the user's hand.

The QR Code can be encrypted prior to printing on the label. The QR Code scanner, such as a smartphone, can read and decrypt the encrypted QR Code to show the submitted data.

A hand-held label maker has an integral QR code (also known as a quick response code) generator. The user can enter text, which will be encoded as a QR code and printed out on a label. The label can be attached to an item to be scanned by any QR Code scanner and the text displayed.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a cross-sectional side view of the hand-held, portable QR Code label printer of the present invention.

FIG. 2 is a top view of the hand-held, portable QR Code label printer of FIG. 1 of the present invention.

FIG. 3 is a top view of a label on a liner for the hand-held, portable QR Code label printer of the present invention.

FIG. 4 is a side view of a label on a liner of FIG. 3 of the present invention.

FIG. 5 is a side view of a label roll for the hand-held, portable QR Code label printer of the present invention.

FIG. 6 is a cross-sectional side view of the hand-held, portable QR Code label printer of the present invention.

FIG. 7 is a cross-sectional side view of the inkjet print head cartridge and platen roller of the hand-held, portable QR Code label printer of the present invention.

FIG. 8 is a perspective view of the inkjet print head cartridge and platen roller of FIG. 7 of the present invention.

FIG. 9 is a side view of the openings in the housing of the hand-held, portable QR Code label printer of the present invention.

FIG. 10 is a side view of a position sensor and a reference mark for the hand-held, portable QR Code label printer of the present invention.

FIG. 11 is a top view of a position sensor and a reference mark for the hand-held, portable QR Code label printer of the present invention.

FIG. 12 is a hand grip handle for the housing of the hand-held, portable QR Code label printer of the present invention.

### DETAILED DESCRIPTION OF PREFERRED EMBODIMENTS

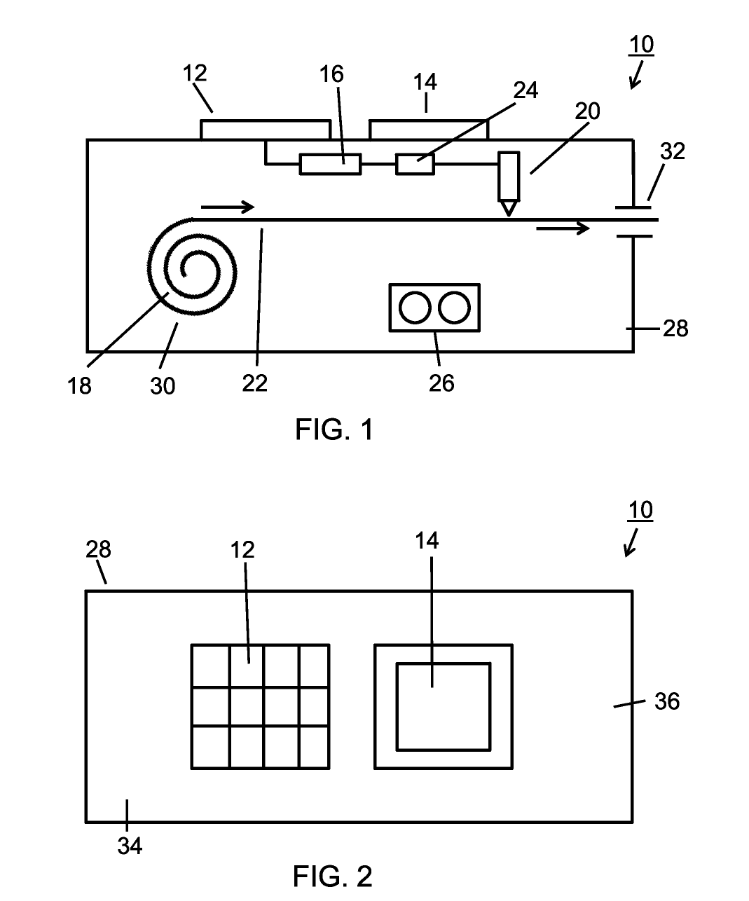

Reference is now made to FIG. 1 and FIG. 2 illustrating a hand-held, portable QR Code label printer 10 of the present invention. The QR Code label printer has the components of a keypad 12 and display screen 14, a controller 16, a plurality of labels 18, an inkjet print head 20, a label delivery system 22, a QR Code generator 24, a battery power source 26 and a housing 28.

The relative sizes and positions of the hand-held, portable QR Code label printer 10 are shown exaggerated in the Figures for ease of understanding of the invention.

More specifically, the hand-held portable QR Code label printer 10 has the keypad 12 for inputting the data and the display screen 14 for displaying the data inputted. The inputted data will be converted by the QR Code generator 24 into a QR Code.

One or more labels 18 are positioned on a label roll 30. The delivery system 22 moves the labels 18 on the roll 30 to the inkjet print head printing system 20. The inkjet printing system 20 prints the QR code from the QR Code generator 24 on a label 18. After the inkjet printing system 20 has printed the QR code on the label 18, the delivery system 22 moves the QR Code printed label through an output aperture 32.

The controller 16 controls the keypad and display screen, the QR Code generator, the inkjet printing system, and the delivery system. The battery power source 26 supplies power to the keypad and display screen, the QR Code generator, the inkjet printing system, the delivery system and the controller.

The housing 28 externally supports the keypad and display screen. The housing internally contains and supports the QR Code generator, the inkjet printing system, the delivery system and the controller. The housing is hand held and portable by the user.

A keypad 12 and a display screen 14 are on the upper side 34 of the housing 28. They keypad is oriented towards the body of the user so the free hand (the hand not holding the label printer) can enter data by the keypad. The display screen is above the keypad on the upper side, closer to the front end 36 of the housing, but oriented towards the body of the user so the user can view the display screen. The keypad can be a conventional push pad or a thin membrane type keypad.

The keypad is used to enter the alphanumeric and symbol data for the QR Code and to control the label printer. The display is used to show the inputted data and the status of the label printing system.

Specifically, the keypad can be a keyboard or any other data entry system for the characters, numbers and symbols of the data.

Function keys on the keypad can control the label printer. The function keys can include start/stop print; adjust label position in the delivery path and under the inkjet print head or at the output aperture; seek status information such as battery strength, delivery motor status, ink supply remaining, and labels remaining; all of the control functions for the controller; and menus,

These function keys can be combinations of keys on a conventional keypad or keyboard. The function keys can be separate keys (not shown in the Figures) on the conventional keypad or keyboard, in addition to the characters, numbers and symbols.

The display screen will display the data entered into the keypad and can display the status of the label printing process. The display screen can be a liquid crystal display (LCD) or a light emitting diode (LED) display or other display. The display can be a black and white display or a color display.

The display can show the specific characters, numbers and symbols of the data entered for the QR Code. The display can also show label printing status; current and past printing instructions; errors (e.g., scanning/positioning/printing error, etc.); status information such as battery strength, delivery motor status, ink supply remaining, and labels remaining; all of the control functions for the controller; and menus.

The display may also show instructions prompts for the user for the function keys of the keypad to control the label printing process.

Alternately, the display screen may be a touch screen or interactive screen for the function keys as opposed to the function keys of the keypad. Also alternately, the keypad may be eliminated so that touch screen or interactive screen can be used as the data entry system for the characters, numbers and symbols of the data and the function keys.

The controller 16 is an application-specific integrated circuit (ASIC). The ASIC is an integrated circuit with a memory and a microprocessor customized to control the keypad and display screen, the QR Code generator, the inkjet printing system, and the delivery system. The memory of the controller will store data and information and the microprocessor will run programs upon command. The controller can be multiple ASICs.

The data from the keypad will be input and stored in the controller 16. The microprocessor in the controller will send the inputted data from the memory to the QR Code generator.

The QR Code generator 24 will run the data through the QR converter program and generate a QR Code. The controller will input the QR Code into the inkjet printing system with the inkjet print head 20 for printing the QR Code symbols on a label. The controller can either (1) input the QR Code directly in real time from the QR Code generator into the inkjet printing system, or (2) store the QR Code in the memory of the QR Code generator and, at a later time, input the QR Code directly from the QR Code generator into the inkjet printing system.

Alternately, the controller can either (3) input the QR Code directly in real time from the QR Code generator to the controller which will, in turn, input the QR Code into the inkjet printing system, or (4) input the QR Code to the memory of the controller and store the QR Code in the memory of the controller and, at a later time, input the QR Code directly from the QR Code generator into the inkjet printing system.

The memory in the controller can include a flash memory, a ROM, A RAM, an EEPROM, a PROM or other integrated circuit memory.

The QR Code generator 24 can be an application-specific integrated circuit (ASIC). The ASIC is an integrated circuit with a memory and a microprocessor customized to generate a QR Code.

The memory in the QR Code generator can include a flash memory, a ROM, A RAM, an EEPROM, a PROM or other integrated circuit memory.

The QR Code generator 24 can be in a section of the controller 16. The keypad data will be in a separate section of the memory of the controller. A microprocessor with the QR converter program will be in a separate section of the memory of the controller. The microprocessor of the QR converter program will run the input data through the QR converter program and generate a QR Code which will be stored in a separate section of the memory of the controller 16.

The controller will input the QR Code into the inkjet printing system for printing the QR Code symbols on a label. The QR Code generator in the controller will receive the QR code data from the display keyboard and process the received data to generate the appropriate QR Code from the data. The controller can store the QR Code or may communicate the QR Code in real-time for printing by the print head.

The inputted data from the keypad will be transmitted to the QR Code generator to be converted into a QR Code on the label. A QR Code scanner device, such as a smartphone, will convert the QR Code on the label back into the inputted data.

The text data can be instructions, warnings, security information, directions, recovery information, language translations, tracking information, or a webpage URL address with more text and pictures.

In the latter application, a smartphone with a QR Code scanner can open the website based on the URL address. The website will have additional information about the physical object, possibly in an information database. A smartphone can display the additional information about the physical object.

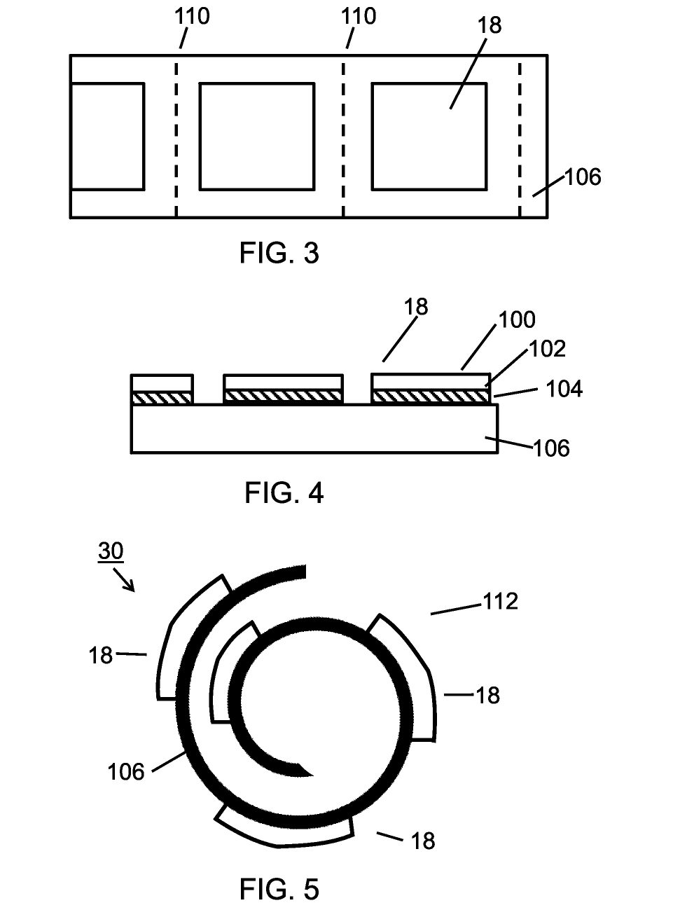

As seen in the top view of FIG. 3 and the side view of FIG. 4, a label 18 has a top surface 100 with a printable surface for the QR Code to be printed on and a bottom surface 102 with an adhesive layer 104. Once the label is attached to an object, the adhesive on the bottom surface of the label secures the label to the top surface of the object.

A label roll will have the label on a liner 106. The adhesive layer 104 on the bottom surface of the label releasably secures the label to the top surface of the liner. The user can remove the label from the liner with the adhesive layer intact on the label to secure the label to an object.

The liner 106 can have a perforation line 110 between adjacent labels 18. After printing, the user can tear the liner along the perforation line to remove the QR Code printed label.

The label can be any shape. QR Codes are square so QR Code labels are square in shape. The labels should be of equal size. There should be equal spacing between the labels on the liner. The perforation line will be in the spacing between labels on the liner, typically equidistant from adjacent labels.

The liner will have a rectangular shape with multiple labels on the liner. The liner will have a width greater than the width of the label. The multiple labels will be uniformly spaced along the length of the liner.

The rectangular shaped liner with the labels provides a slim width profile which accommodates the small size of a handheld printer. The liner with labels provides ease of loading in the compartment, ease of use in aligning with the delivery system and the printing system, ease of use in printing the labels, and ease of removal of the QR Code printed label from the liner.

A roll of labels reduces costs, improves manufacturability, and increases productivity.

The labels 18 on the liner 106 will typically be wound in a roll 112, as seen in FIG. 5. The resulting label roll 30 will be around a spool or a spindle.

The labels on the liner width may be of any suitable lateral dimension, but typical sizes include widths between one half inch to one and two inches. These widths are suitable for the dimensions of a hand held printer. Preferably, the labels on the liner is approximately between 15 to 25 mils thick. This thickness range has to balance the opposing requirements that the labels on the liner be flexible enough to pass through a printer but robust enough for the delivery system and further use as a QR Code label attached to the surface of an object.

However, the invention is not limited to labels on the liner having the above dimensions. For example, labels on the liner thicker than described above, may be desired if flexibility of the liner is not as important as stiffness of a printed label. The size, color, and material of the label and liner can vary depending upon the particular printing application.

After printing and exit from the printer, the user will tear or cut along the perforation line to remove a single QR Code printed label on a section of liner. The label will be removed, typically by peeling, from the liner with the adhesive layer remaining on the bottom surface of the label. The user can then secure the QR Code label by the adhesive layer to an object.

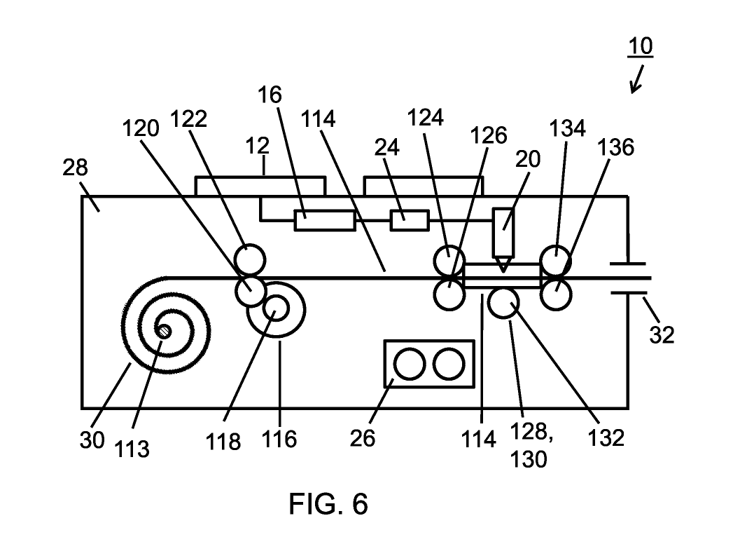

The housing 28 for the label printer 10 of FIG. 6 has an internal compartment for mounting a label roll 30 on a spindle 113. The label roll will freely revolve on the spindle with limited or no friction.

The label roll is guided along a delivery path 114 through the interior of the label printer 10. The labels will be feed out of the spindle, a QR Code printed on the label at the inkjet print head 20, and then exit the label printer through an output aperture 32 for use.

An electric motor 116, such as a stepper motor, has a rotary output shaft 118. The rotary output shaft drives a drive roller 120. The drive roller has an opposing passive roller 122. The label on a liner from the label roll is positioned between the drive roller and the passive roller and in contact with the driver roller and the passive roller. The drive roller rotates and moves the labels along the drive path. (The elements in the Figure are not drawn to scale but are shown expanded for ease of understanding.)

The labels pass between and are in contact with another pair of passive rollers 124, 126 adjacent and prior to the inkjet print head 20 in the delivery path 114. The passive rollers are on the top surface and bottom surface of the label, respectively.

The label printer can include guides to position the label before and during printing. A right vertical adjustable guide 128 and a left vertical adjustable guide 130 are on the right side and the left side respectively of the label. The guides are adjustable by the user through an opening in the housing to prevent label jams or label misalignment.

The passive rollers 124, 126 and the guides 128, 130 will position and properly align a label between the print head 20 and a platen 132 (a platen roller) for the print head to print the QR Code on the label. The alignment will be up and down by the passive rollers and left and right by the reference guides.

The printed label passes through and in contact with another pair of passive rollers 134, 136 adjacent and after the inkjet print head 20 in the delivery path 114 but prior to the output aperture 32. The passive rollers are on the top surface and bottom surface of the label. The passive rollers will advance the printed label through the output aperture and out of the label printer for use.

The printed label will be torn along the perforation line, the printed label will be removed from the liner, and the printed label will be attached by the adhesive to the object to display the QR Code.

The print head can print on successive labels while the label roll is advanced by the driver roller (driven by the motor) and the passive rollers. The drive roller is a feed roller.

The driver roller and the passive rollers can have gripping surfaces to secure the label roll on the drive path and position the label for printing and exit through the output aperture. The gripping surfaces are typically rubber, resin, polymer, or some other resilient elastomeric material. The gripping surfaces may be textured or patterned.

The motor is powered by the battery power source 26 and is controlled by the controller 16.

Because of the handheld portable size of the label printer, the rollers are in close proximity to the motor, label roll, inkjet print head and the output aperture. This close proximity helps reduce mis-alignment or jamming of the label under the print head during the printing of the QR Code on the label.

The passive rollers can be spring biased to be in contact with the label along the drive path. The passive rollers can be considered pinch rollers.

The electric motor under the control of the controller can stop and reverse the direction of the label in the drive path.

The controller will synchronize the label delivery system and the printing system.

The rotary output shaft is a gear drive. Additional interlocking gears can be provided between the drive gear and the drive roller to provide the necessary size and speed of rotation of the drive roller and this control the advancement of the labels along the drive path.

The print command from the keypad 12 will be transmitted to the controller which will execute the command by coordinating the delivery system and the printing system.

The controller will control the motor of the delivery system to advance the label roll within the label printer to position the blank label under the print head of the printing system.

Once the label has been positioned under the print head, the controller will control the print head to deposit ink on the blank label corresponding to the QR Code pattern.

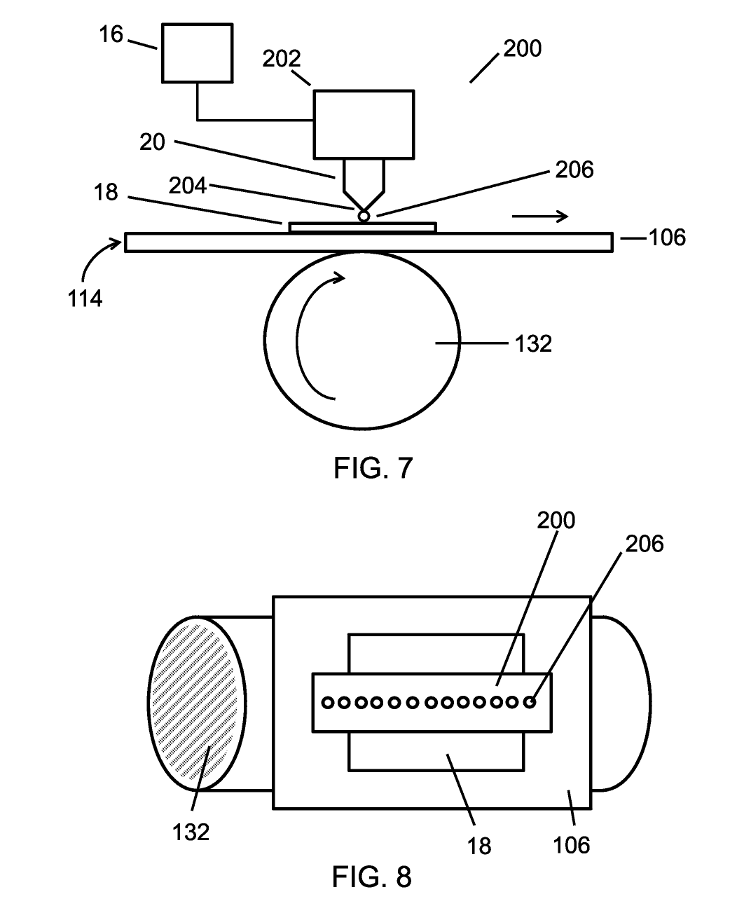

As seen in FIG. 7 and FIG. 8, inkjet print head printing involves ejecting ink from an inkjet print head 20 onto the label 18 on the liner 106. There is no physical contact between the inkjet print head and the label. The methods of inkjet printing may use pressurized nozzles, electrostatic fields, piezo-electric elements and/or heaters for ink droplet formation and deposition.

The inkjet print head of the present invention is typically part of an inkjet printing cartridge.

The inkjet print head cartridge 200 is inside a compartment in the housing with an external compartment cover to remove and replace the inkjet print head cartridge. The compartment supports and holds the print head cartridge 200 in a fixed position relative to the platen 132 or platen roller of the label printer 10. The print head cartridge is electronically coupled to the controller.

An inkjet printing cartridge 200 will have ink reservoirs 202 for the print head, the print head 20 and an electrical circuitry 204 to the controller. The print head may be an inkjet print head having a plurality of nozzles 206 designed to emit liquid ink droplets 208. The ink will be contained in the reservoirs and dispensed through the nozzles, controlled by the controller, in a QR Code pattern onto the blank label. Typically, the ink for the QR Code label is black.

The nozzles are typically arranged in a straight line, a double line, or a double staggered line on the print head to form a straight line of ink on the label for the QR Code pattern.

The delivery system positions the blank label under the inkjet print head and advances the label line by line under the control of the controller. The controller controls and coordinates both the inject print head and the delivery system.

The controller also controls the inkjet print head so that ink can be printed line by line to form the QR Code pattern on the label.

A QR Code image is formed on the label by ejecting a series of ink dots from the inkjet print head onto the label in a selected pattern. The ink dots can be ejected on a line by line basis (a “line” meaning a row of dots), so that the net visual effect of a plurality of lines is the desired QR Code image. The QR Code is digitally formatted on a line by line basis, in its simplest form as a series of on/off commands to each inkjet print head nozzle 30 under control of the microprocessor of the controller. The digitized representations of the QR Code can be stored in the electronic memory of the QR Code generator or the controller.

An inkjet printing cartridge 200 is small in size, is low cost, and is easily removable and replaceable within the inkjet print head compartment of the label printer.

The controller determines a printing area on the label where the QR Code will be printed. The printing area is not equal to the size of the label. The printing area is smaller than the size of the label. The controller may expand, reduce, or rotate the QR Code to determine the printing area on the label to print the QR Code in the printing area of the label.

The power supply for the hand-held, portable QR Code label printer supplies power to the keyboard, the display, the QR code generator, the controller, the motor for the delivery system, and the inkjet print head for the printing system.

The power supply may be a single battery or multiple batteries in series.

The power supply may be a replaceable battery to supply power to the electronic components of the hand-held printer 10. The replaceable battery may be a conventional battery, such as an alkaline battery, or a rechargeable battery, such as a nickel-cadmium battery.

The conventional battery will be positioned in the battery compartment as the power supply for the electrical and electronic components of the label printer. The power will be drained from the conventional battery during operation of the QR Code label printer. The dead conventional battery will be removed from the compartment and disposed of. A new replacement battery will be then be positioned in the battery compartment as the QR Code label printer power supply.

The rechargeable battery will be positioned in the battery compartment as the power supply for the electrical and electronic components of the label printer. The power will be drained from the rechargeable battery during operation of the QR Code label printer. The dead rechargeable battery will be removed from the compartment and recharged in a battery recharging system (not shown). The recharged replacement battery will be then be positioned in the battery compartment at a present or future time as the QR Code label printer power supply. A fresh conventional battery or another charged rechargeable battery can be positioned in the battery compartment as the QR Code label printer power supply.

The housing provides a recessed compartment for the battery or batteries in the power source, for example two 1.5 V “AAA” batteries.

A battery storage compartment will store the substantially bar-shaped rechargeable battery. The compartment is in internal within the housing.

A battery compartment cover is detachably provided to this battery storage compartment. With the battery compartment cover is opened, the battery storage compartment opens to the side surface section of the housing.

The controller receives operational commands from the function keys of the keypad. The controller controls the delivery system, the inkjet printing system and the QR Code generator.

The battery power source supplies power to the controller.

The printing function consists of a first delivery function of moving the label to the printing position, the transfer of the QR Code to the ink jet print head, the printing of the QR Code on the label, and the second delivery function of moving the printed label to the output aperture.

The first delivery program, the QR Code transfer program, the printing program and the second delivery program can be separate programs in separate sections of the memory of the controller. Alternately, the programs can be one program.

The first delivery program can be run by a first microprocessor to control the motor and delivery system to deliver the label from the roll to the printing position.

The QR Code transfer program can be run by a second microprocessor to deliver the QR Code from the QR Code generator memory or the controller memory (depending upon where the QR Code is stored) to the inkjet printer.

The printing program can be run by a third microprocessor to control the motor and the delivery system and the inkjet printing system to print the QR Code on the label.

The second delivery program can be run by a fourth microprocessor to control the motor and delivery system to deliver the printed label to the output aperture.

The microprocessor of the controller can be a single microprocessor to run the first delivery program, the QR Code transfer program, the printing program and the second delivery program in sequence.

In operation, the start printing command will be entered by the user into the keypad and transmitted from the keypad to a section of the memory or in a separate chip, module or device of the controller.

The first delivery program is in a separate section of the memory or in a separate chip, module or device of the controller. The first microprocessor will run the start printing command through the first delivery program and the controller will control the motor and the delivery system through the first delivery system to advance a label on the roll of labels to the printing position below the inkjet print head.

The QR Code transfer program is in a separate section of the memory or in a separate chip, module or device of the controller. The second microprocessor will run the start printing command through the QR Code transfer program and the controller will transmit the QR Code from the memory of the QR Code generator or transmit the QR Code from the memory of the controller to the inkjet printing system.

The printing program is in a separate section of the memory or in a separate chip, module or device of the controller. The third microprocessor will run the start printing command through the printing program and the controller will control the printing of the QR Code on the label and the motor of the delivery system to advance the label during the printing below the inkjet print head.

The second delivery program is in a separate section of the memory or in a separate chip, module or device of the controller. The fourth microprocessor will run the start printing command through the second delivery program and the controller will control the motor and the delivery system to deliver the printed label to the output aperture.

The controller can monitor the completion or each step of the printing function and/or the completion of the label printing and its output through the aperture and transmit a status report to the display.

A stop print command entered by the user in the keypad will be transmitted to the controller to stop printing at any step of the printing function. Another stop print command entered by the user in the keypad will be transmitted to the controller to stop printing at the completion of the current step of the printing function.

A sensor can be positioned to measure the diameter of the label roll to determine the number of labels remaining on the roll. A sensor can be positioned in the battery power source circuit to measure the remaining battery strength. A sensor can be positioned in the inkjet print head to determine the amount of remaining ink.

A function command for the status of the labels, battery or ink entered by the user in the keypad will be transmitted to the controller. The controller will transmit a status check signal to the sensor for the labels, battery or ink and receive a status report signal back from the sensor for the labels, battery or ink. The controller will send a status check report on the labels, battery or ink to the display.

The power supply for the hand-held, portable QR Code label printer supplies power to the keyboard, the display, the QR code generator, the controller, the motor for the delivery system, and the inkjet print head for the printing system.

The controller will control the power to the keyboard, the display, the QR code generator, the motor for the delivery system, and the inkjet print head for the printing system. The power supply will automatically supply power to the controller and the keypad and display for the label printer upon turning on the label printer.

As used herein, the term “application specific integrated circuit” is not limited to just those integrated circuits referred to in the art as ASIC, but broadly refers to one or more microcomputers, processors, microcontrollers, or any other suitable programmable circuit or combination of circuits.

The label printer 10 is designed to be grasped and positioned by a user's hand while printing a QR Code label on location to be secured upon the surface of the desired object. The label printer is also designed to be lightweight, portable to location, and yet rugged enough to be dropped and still function and water and dust resistant. The housing provides these function for the label printer.

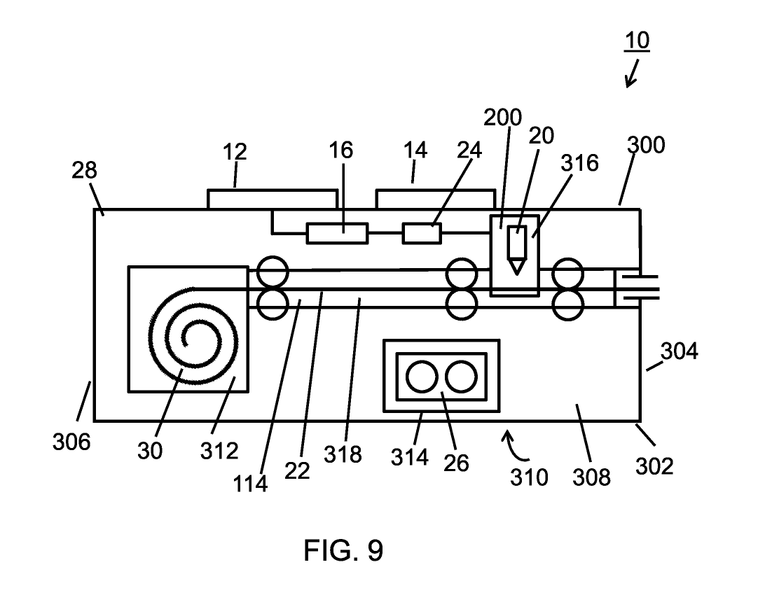

The housing 28 for the hand-held, portable QR Code label printer 10 as shown in FIG. 9 is generally three dimensional rectangular in shape with a top side 300, a bottom side 302, and then a front side 304, a back side 306, a right side 308 and a left side 310 between the top side and the bottom side.

The housing 28 externally supports the keypad 12 and display screen 14 on the top side 300. The housing 28 internally contains and supports the controller 16, the QR Code generator 24, the inkjet printing system 20, the delivery system 22, and the battery power source 28.

The bottom side 302 of the housing is the surface that the user will hold in the user's hand. For ease of use and comfort, the bottom side can be convex curved or ergonomically shaped for being held by either the right or left hand of the user.

A strap can fit about the back of the user's hand. The strap is secured at both ends to opposite sides of the housing. The strap can be multiple straps in parallel along the back of the user's hand or multiple straps in a criss-cross pattern along the back of the user's hand.

A label roll opening 312 in the housing allows for outside removal and replacement of the internal label roll 30. A battery power source opening 314 in the housing allows for outside removal and replacement of the internal battery power source 26. An inkjet cartridge opening 316 in the housing allows for outside removal and replacement of the inkjet cartridge 200.

Opening 318 in the housing allows for the realignment and repositioning of the label along the delivery system path 114 inside the housing.

The openings will be large enough to permit easy removal and replacement of the components in and out of the housing and realignment of the labels within the housing.

Each opening in the housing will have a cover. The cover will have a snap latch on one side and a hinge on the opposite side.

The cover is mounted to the exterior of the housing by the hinge. When the cover is in the closed position, the latch will engage and edge of the opening causing the cover to cover the opening. When the cover is in the open position, the opening is open for removal/replacement/realignment of the components insides the housing through the opening.

The cover can pivot on the hinge from open to closed and closed to open with the latch securely closing the cover relative to the housing. The cover is in the closed position for operating the label printer and can be in the open position when the label printer is not operating. The latch releasable holds the cover in the closed position.

The cover provides a snug, secure fit over the opening to prevent dust and debris from entering the interior of the housing and its components and to prevent the covers from opening during transit and use on location.

The cover can have two snap latches on opposing sides in which case the cover will be completely removed during removal/replacement/realignment of the components inside the housing.

The removable and replaceable components of the hand-held, portable QR Code label printer 10 are the label roll 30, the inkjet printing cartridge 200, and the battery power source 26. The label roll 30 and the delivery system 22 are the components of the label printer that may need to be internally aligned inside the label printer.

The covers allow replacement of the components, alignment of the label on the delivery path and the removal of obstructions along the delivery path.

The label roll, the inkjet printing system, and the battery power source will be in compartments inside the label printers. These compartments can cover the component on five sides with open cover being the sixth side.

The label roll can have a single separate cover from the other component covers. The inkjet printing system can have a single separate cover. The battery power source can have a single separate cover. The delivery path can have one or more separate covers.

Alternately, a single cover can cover the compartments for two or more adjacent component compartments. The battery power source and the inkjet printing cartridge can share a cover.

Again alternately, a single cover can cover the compartments for the label roll, the inkjet printing system, the battery power source and the delivery system.

The label printer housing 28 is a rigid structure that is capable of supporting the external keypad and display screen on the top side and the internal QR Code generator, controller, inkjet printing system, delivery system, and battery power source.

The housing should also be sturdy enough to withstand the rugged use while being mobile and operating at a location.

A rigid and supportive material is used for the housing and covers such as plastics, metal, polymer, composites, or resin. The housing and covers will typically be formed by injection molding. The covers are then attached to the housing by hinges or snap latches. The housing can be formed of multiple molded parts which are attached together.

The housing can have a label output opening in the top surface near the front surface or in the front surface.

The covers can be all along the same side of the label printer. This side access to the components is referred to as a side-loading printer.

The label roll can have a cover on the back side of the line printer with the label roll compartment inside the housing. This is a back-loading printer.

The label roll, the inkjet print cartridge and the battery power supply can have covers on the top side of the housing with the respective compartments inside the housing. This is a top-loading printer.

The label roll and the battery power supply can have covers on the bottom side of the housing with the respective compartments inside the housing. This is a bottom-loading printer.

Generally, the inkjet print cartridge will be a side-loader or a top-loader.

Generally, the delivery path will be a side-loader.

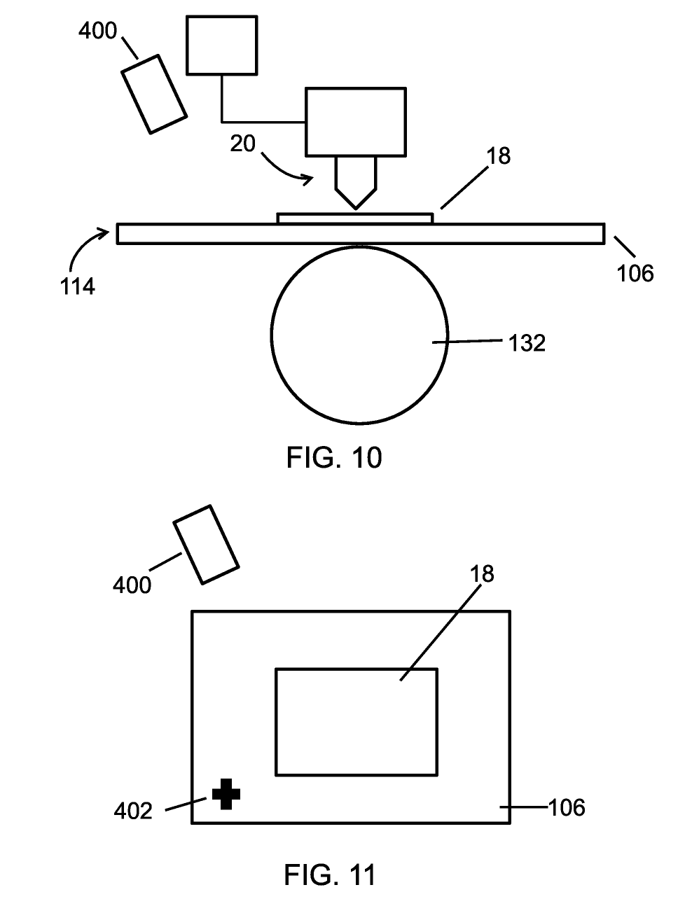

Alternatively, a position sensor 400 in FIG. 10 and FIG. 11 above the delivery path 114 and a reference mark 402 on the liner 106 of the label 18 can determine and correct the position of the label with respect to the inkjet print head. The platen roller 132 is opposite the inkjet print head 20 with the label and liner between the print head and platen roller.

The position sensor will be located adjacent to the print head 22 and prior to the print head in the delivery path 114.

The label roll has multiple labels on a liner. The reference mark, which can be a simple cross of two black lines, is on the top surface of the liner in an area not covered by the label. The reference mark will typically be above the label, along one side of the label or below the label. The reference marks for labels will be in the same relative position for each label.

The position sensor is electronically connected to the controller. The controller controls both the delivery system and the inkjet printing system.

The position sensor can send a position signal to the controller upon alignment with the reference mark on the liner. The controller will then control the motor of the delivery system and the commencement and completion of the printing of the QR Code symbol on the label by the inkjet printing system. The controller will coordinate and synchronize the advancement of the label with the printing on the label.

The controller will direct and control the print head to deposit ink on the label to represent the corresponding line of the QR Code symbol as the label advances by line.

The label printer can have multiple position sensors and multiple reference marks on the liner of the label.

The location sensor can be below the delivery path, adjacent to the platen and before the print head in the delivery path. The reference mark will be on the bottom surface of the liner.

The location sensor can be an optoelectronic sensor or a phototransistor and a light emitting diode (LED). Without the reference mark, the location sensor can be an electromechanical sensor or an inertial sensor.

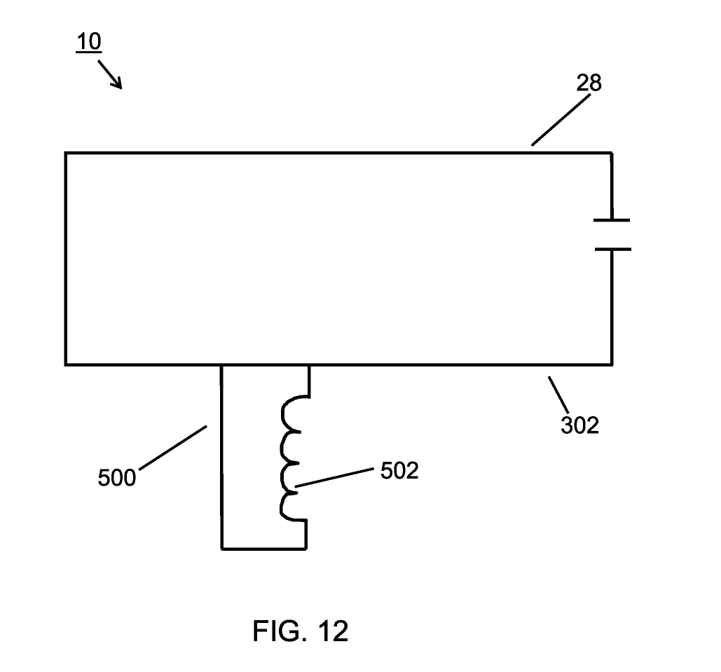

Alternately, a hand grip handle 500 in FIG. 12 can extend generally perpendicular from the flat bottom surface 302 of the label printer 10 housing 28. The user will grip the handle in the user's hand rather than hold the label printer in the palm of the user's hand. The bottom surface of the label printer will not be curved or ergonomical in shape.

The hand grip handle will be generally oval in cross-sectional shape and the outer surface 502 of the handle can be ergonomical for gripping the handle with the fingers and palm of the user's hand.

The handle can have a compartment inside with a hinged cover and a latch. The compartment can hold the battery power source which can be removed and replaced.

If the handle is positioned towards the back surface of the label maker, the handle can have a compartment inside with a hinged cover and a latch. The compartment can hold the label roll which can be removed and replaced. The handle will have an open top and the bottom surface will have a corresponding open section of the bottom surface so the delivery system can move the labels along the delivery path to the inkjet printing system.

The QR Code can be encrypted by a program running on the QR Code generator, or the controller, prior to printing. The QR Code scanner with the proper decryption program can decrypt the encrypted QR Code to display the QR Code and the data in the QR Code.

After the QR Code is generated but before the QR Code is printed on the label, the QR Code generator can store the QR Code in a memory. An encryption program can be in another section of the memory or in another memory of the QR Code generator. A microprocessor in the QR Code generator will run the encryption program and encrypt the QR Code. The encrypted QR Code will be stored in another section of the memory or in another memory of the QR Code generator. The encrypted QR Code will be printed on the label.

The encryption program, memory and microprocessor can be in the controller, rather than the QR Code generator.

The encryption program can be as simple as a password protected QR code requiring a password to view the QR Code. The encryption program can use an encryption key in the label printer and a different decryption key in the QR Code scanning device.

Rather than the black ink for the QR Code label, a colored ink may be used as an alternative to better attract attention to the label attached to an object.

For increased security of the data in the QR Code and to decrease attention, the label printer can print special inks that are only visible under infra-red (IR) illumination for the QR Code label. The IR ink is deposited on the label in a QR Code pattern that can be recognized by an IR sensor, a physical IR filter or an electronic IR filter in the software of the QR Code scanning device.

Similarly, the QR Code label can be printed using ultraviolet (UV) sensitive ink so that the QR Code label is only visible in ultraviolet (or black light) illumination to be recognized by a UV sensor, a physical UV filter or an electronic UV filter in the software of the QR Code scanning device.

Other than the ink jet printer, the printing component of the QR Code label printer may be a dot matrix printer, laser printer, solid ink printer, dye-sublimation printer, or thermal transfer ribbon printer.

The display for the QR Code label printer may be a color display or a display using another single color, other than black, for ease of use in an outdoor or indoor environment.

The controller may process the QR Code data from the QR Code generator to facilitate the label printing process. Image processing techniques may include dithering, decompression, half-toning, and/or image storage.

The QR Code generator can be positioned between the keypad and the controller. The input data from the keypad can be transmitted to the QR Code generator. The QR Code generator will convert the input data to the QR Code. The QR Code from the QR Code generator can be transmitted to the controller. The controller will then transmit the QR Code to the printing system.

As an alternative, the QR Code label printer may have a manual cutter at the label output aperture. The manual cutter will be adjacent to the aperture either inside the housing or outside the housing. The cutter will be operated by the user to remove a label from the label roll. The manual cutter will replace the perforations between adjacent labels on the label roll. If need be, a label location sensor may be used to position the label for cutting. The sensor will report the label location to the controller to control the delivery system and stop the label roll to permit cutting the label in the space on the roll between labels.

The multiple labels need not be on a label roll on a spindle. Multiple square labels can be spaced along a long length-wise rectangular liner.

There should be equal spacing between the labels on the liner. The perforation line will be in the spacing between labels on the liner, typically equidistant from adjacent labels.

The labels on the liner can be folded at regular length intervals along the perforation lines and stacked by being laid flat and layered in a zig-zag pattern in a tray. The tray can be inserted through a hatch in the housing to the starting point of the delivery system. The delivery system will remove the first regular length of the liner with the labels and transport them to the printing system. The labels are printed with the Quick Code and exit through the exit output aperture in the housing.

Again, alternately, a single label on a liner can be inserted through an input aperture in the housing to the starting point of the delivery system. The delivery system will transport the label on a liner to the printing system. The label is printed with the Quick Code and will exit through the exit output aperture in the housing.

The hatches allowing access to the inside of the housing and the various components of the QR Code label printer can be on the top side of the housing, either side of the housing or the bottom side of the housing or some combination of the top, side and bottom sides of the housing. The label roll, print head and battery power source can be loaded and removed and replaced through the opened hatch in the housing. Technically, these hatches are top-loaders, side-loaders or bottom-loaders for the various components of the QR Code label printer. The hatch or hatches for clearing and aligning the labels from the label roll to the exit output aperture can similarly be on the top side of the housing, either side of the housing or the bottom side of the housing or some combination of the top, side and bottom sides of the housing.

The power source in the QR Code label printer is one or multiple batteries. The batteries can be removed and replaced from the battery compartment inside the housing. The batteries are disposable or rechargeable.

An alternative is to recharge the battery while the batteries are still in the battery compartment inside the housing of the QR Code label printer.

In both uses of a conventional battery or a rechargeable battery as the power supply, the battery must be fully removed and replaced or fully removed, recharged and replaced.

In the alternative embodiment, the battery would remain in the battery compartment without being removed and/or replaced upon being drained by operation of the label printer.

An external connection would allow for a standard electrical connection to an internal battery charging system. The battery charging system or the external port or the battery compartment may have a battery charging circuit between the battery charging system and the battery to control the flow and amount of power to the battery and to cease charging once the battery has been fully charged. The battery charging system may be a one or more external batteries or a power line adapter.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A label printer comprising
a keypad and display screen for inputting data from a user;
a Quick Response Code generator for translating said data from said keypad into a Quick Response Code;
a printing system for printing said Quick Response Code from said Quick Response Code generator onto a label;
one or more labels releasably attached by an adhesive to a liner;
a label delivery system having a motor to rotate a drive roller, said drive roller moving a label to said printing system and then to an output aperture;
a controller for controlling said keypad, said display screen, said Quick Response Code generator, said printing system, and said motor for said label delivery system;
a battery power supply for supplying power to said keypad, said display screen, said Quick Response Code generator, said printing system, said motor for said label delivery system, and said controller; and
a housing for supporting said keypad and said display screen on the outer surface of said housing; said housing supporting said Quick Response Code generator, said printing system, said labels, said label delivery system, said controller, and said battery power supply inside said housing; and said housing being hand-held by said user and portable by said user.

2. The label printer of claim 1 wherein said one or more labels releasably attached by an adhesive to a liner form a label roll.

3. The label printer of claim 1 wherein said printing system is an inkjet printing system.

4. The label printer of claim 1 wherein said Quick Response Code generator is an application-specific integrated circuit and said controller is an application-specific integrated circuit.

5. The label printer of claim 1 further comprising
an encryption program wherein said Quick Response Code is encrypted prior to said Quick Response Code being printed onto a label.

6. The label printer of claim 1 wherein a bottom surface of said housing is curved or has an ergonomical shape for the user to hold said label printer in the user's hand.

7. The label printer of claim 1 further comprising
a hand grip handle extending generally perpendicular to a bottom surface of said housing has for the user to hold said label printer by said hand grip handle in the user's hand.

8. The label printer of claim 1 wherein said battery power supply is one or more batteries, said one or more batteries being removable and replaceable.

9. The label printer of claim 1 further comprising
multiple openings in the housing for access to said labels, said battery power source and the print head of said inkjet printing system so that said labels can be replaced, said battery power source can be removed and replaced, and said print head of said inkjet printing system can be removed and replaced, and
each opening of said multiple openings having a hinged cover with latch allowing each opening to be open or closed.

10. The label printer of claim 1 further comprising
a location sensor; and
a reference mark on said liner for each of said one or more labels, wherein said location sensor and said reference mark position said label relative to said printing system for printing said Quick Response Code onto said label.

11. A label printer comprising
a keypad and display screen for inputting data from a user;
a application-specific integrated circuit Quick Response Code generator for translating said data from said keypad into a Quick Response Code;
an encryption program wherein said Quick Response Code is encrypted as an encrypted Quick Response Code;
an inkjet printing system for printing said encrypted Quick Response Code from said application-specific integrated circuit Quick Response Code generator onto a label;
one or more labels releasably attached by an adhesive to a liner to form a label roll;
a label delivery system having a motor to rotate a drive roller, said drive roller moving said label roll and moving a label to said inkjet printing system and then to an output aperture;
an application-specific integrated circuit controller for controlling said keypad, said display screen, said application-specific integrated circuit Quick Response Code generator, said inkjet printing system, and said motor for said label delivery system;
a battery power supply for supplying power to said keypad, said display screen, said application-specific integrated circuit Quick Response Code generator, said inkjet printing system, said motor for said label delivery system, and said application-specific integrated circuit controller; said battery power supply being one or more batteries; said one or more batteries being removable and replaceable; and
a housing for supporting said keypad and said display screen on the outer surface of said housing; said housing supporting said application-specific integrated circuit Quick Response Code generator, said inkjet printing system, said labels, said label delivery system, said application-specific integrated circuit controller, and said battery power supply inside said housing; said housing being hand-held by said user and portable by said user;
multiple openings in the housing for access to said labels, said battery power source and the print head of said printing system so that said labels can be replaced, said battery power source can be removed and replaced, and said print head of said inkjet printing system can be removed and replaced, and
each opening of said multiple openings having a hinged cover with latch allowing each opening to be open or closed.

12. The label printer of claim 11 wherein a bottom surface of said housing is curved or has an ergonomical shape for the user to hold said label printer in the user's hand.

13. The label printer of claim 11 further comprising
a hand grip handle extending generally perpendicular to a bottom surface of said housing has for the user to hold said label printer by said hand grip handle in the user's hand.

14. The label printer of claim 11 further comprising
a location sensor; and
a reference mark on said liner for each of said one or more labels, wherein said location sensor and said reference mark position said label relative to said printing system for printing said Quick Response Code onto said label.
